(19) United States
(12) Patent Application Publication
(10) Pub. No.: US 2008/0271112 A1
(43) Pub. Date: Oct. 30, 2008

(54) AUTOMATIC FILE TRANSFER

(76) Inventors: Philip M. Waker, Fort Collins, CO (US); William G. McCollom, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/741,800

(22) Filed: Apr. 30, 2007

(51) Int. Cl. H04K 1/00

(52) U.S. Cl. 726/1

(57) ABSTRACT

A computer-readable medium contains software that, when executed by a processor, causes the processor to perform various actions. For example, as a result of a user-initiated event, the software causes the processor to automatically select at least one file from among a plurality of files based on a policy, and to automatically transfer the selected at least one file across a network.

### BACKGROUND

A digital camera typically has memory which can store a finite number of pictures. A photographer, therefore, can take only a limited number of pictures before the pictures stored on the camera must be off-loaded, for example, to a computer, to make room for more pictures. A photographer may not always have easy access to a computer to off-load the pictures. For example, while on a vacation, the photographer may not have access to a computer.

### BRIEF DESCRIPTION OF THE DRAWINGS

For a detailed description of exemplary embodiments of the invention, reference will now be made to the accompanying drawings in which:

FIG. 1 shows a system in accordance with various embodiments;

FIG. 2 shows a method in accordance with various embodiments;

FIG. 3 shows another system in accordance with various embodiments;

FIG. 4 shows a method related to the system of FIG. 3;

FIG. 5 shows another system in accordance with various embodiments; and

FIG. 6 shows a method related to the system of FIG. 5.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

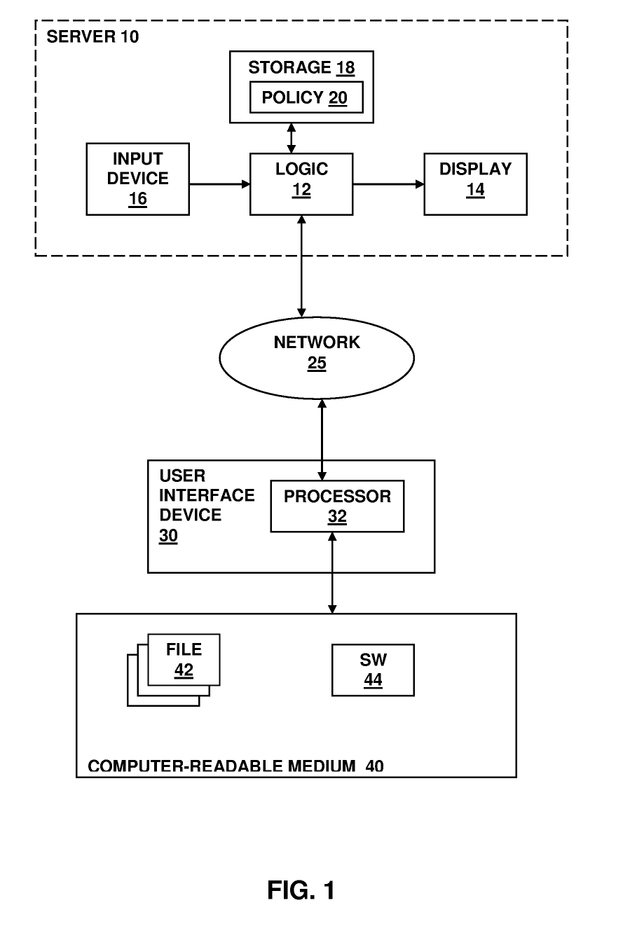

FIG. 1 illustrates a computing device 10 (e.g., a server) coupled to a user interface device 30 via a network 25. The server 10, which may be a home server, comprises logic 12 coupled to a display 14, an input device 16 (e.g., keyboard, mouse, etc.), and storage 18. The logic 12 comprises a processor in various embodiments that executes software (e.g., operating system, applications, etc.) stored on storage 18. Via the input device 16 and display 14, a user can interact with the server 10. The storage 18 also stores policy 20, the use of which is described below. Policy 20 is generated and/or edited by a user of the server 10 via the input device 16 and display 14.

The network 25 comprises a local area network (LAN), a wide area network (WAN), or other type of network through which the server 10 and user interface device 30 communicate with each other. In some embodiments, the network 25 comprises the Internet. The user interface device 30 communicates with the server 10 from a location close to (e.g., in the same room) or remote from (e.g., in different rooms, buildings, geographical locations) the server 10.

The user interface device 20 comprises a computer in accordance with at least some embodiments. As such, the user interface device 20 comprises a processor 32 and may comprise other components (e.g., memory, keyboard, display, etc.) as desired.

In accordance with various embodiments, a portable computer-readable medium (CRM) 40 is also provided and may be removably coupled to the processor 32 of the user interface device 20. The CRM 40 comprises any of a variety of non-volatile storage devices. Examples comprise Flash memory, electrically-erasable read-only memory (EEPROM), etc. The CRM 40 may also comprise battery-backed random access memory (RAM). In some embodiments, the CRM 40 comprises a memory device from a digital camera. In accordance with some embodiments, the CRM 40 comprises a U3 drive. A U3 drive comprises a universal serial bus (USB) interface for coupling to the user interface device 20. Further, a U3 drive is capable of storing software that is executable by the computer to which the U3 drive is coupled. The software stored on a U3 drive is automatically executed by the host computer.

The CRM 40 stores one or more files 42. Each file 42 comprises any of a variety of types of information such as images (e.g., digital photographs), video, audio, text, authentication digests, file metadata. A file 42 may comprise one such type of information or combinations of two or more types of such information. Further, one file 42 may comprise one type of information (e.g., digital photographs), while another file comprises a different type of information (e.g., text). In

In at least some embodiments, the CRM 40 also comprises software 44 which is executable by processor 32 of the user interface device 30 when the CRM 40 is coupled to the user interface device 30. In some embodiments, the software 44 is automatically executed upon a user coupling the CRM 40 to the user interface device 30. For example, in some embodiments as noted above, the CRM 40 comprises a U3 drive. A characteristic of a U3 drive, as noted above, is that software contained therein can be executed automatically upon coupling the U3 drive to a computer (a feature sometimes referred to as “Autoplay”).

In accordance with the disclosed embodiments, a user causes one or more files to be automatically transferred from the CRM 40 across the network 25 to a destination location such as server 10. For example, each time the user couples the CRM 40 to the user interface device 30, the software 44 automatically executes on the processor 32 to select files 42 in accordance with the policy 20 and transfer the selected files to the server 10. Automatic execution of the software 44 comprises the processor 32 executing the software 44 without being a prompt from the user-execution of the software 44 is caused by the user coupling the CRM 40 to the user interface device 30.

In some embodiments, Internet Protocol (IP) address, Uniform Resource Locator (URL) or other identifying mechanism of the server 10 is programmed onto the CRM 40. This identifying mechanism is used by the software 44 to establish a communication channel between the user interface device 30 and the server 10 via the network 25. In such embodiments, the user interface device 30 accesses the same server 10 to receive the transferred files 42 each time the user couples the CRM 40 to the user interface device 30.

After uploading the files from the CRM 40 to the server 10, the user can delete the files that were transferred from the CRM 40 and save new files to the CRM 40 to be uploaded the next time the user couples the CRM to the user interface device 30. In other embodiments, the user can leave the files that were transferred on the CRM. While in some embodiments, all files 42 are transferred from the CRM 40 to the server 10, in other embodiments, one or more, but not necessarily all, of the files 42 are transferred to the server. The file(s) that are selected for transferring to the server 10 are selected based on the policy 20.

The policy 20 is configured by the user of the server 10 and comprises one or more criteria used to determine which files are to be transferred from the CRM 40 to the server 10. Table I provides an illustrative list of criteria that can be implemented as part of the policy. The policy comprises any one or more of such criteria. Other criteria can be implemented as well as part of the policy.

TABLE I
POLICY

| Policy Criterion | Description |
|---|---|
| No repeat transmission | Transfer only those files from CRM 40 |
| | that have not previously been |
| | transferred. |
| File type | Transfer only those files from CRM 40 |
| | of a specified type. |
| File size | Transfer only those files less than a |
| | specified size. |
| File name | Transfer only those files having a |
| | particular name or a particular string of |
| | characters within the name. |
| Multipurpose Internet | Transfer only files with certain MIME |
| Mail Extensions (MIME) type | types (e.g., Portable Network Graphics |
| | (PNG) MIME type). |
| Metadata | Transfer files with certain metadata |
| | descriptions such as pictures involving |
| | outdoor scenery. |
| File creation date | Transfer only those files from CRM 40 |
| | that were created after a specified date. |
| File copyright | Transfer only files that are not tagged |
| | with a copyright notice or not tagged |
| | with a copyright notice of a user- |
| | specified entity. |
| File descriptive information | A subset of metadata. |
| File authenticity | Transfer only files that are |
| | accompanied by a valid Message |
| | Authentication Code that matches a |
| | calculated Digest for the file. |
| File Ownership | Transfer only files that were created by |
| | a specific user name. |
| File Encryption | Transfer only those files that have been |
| | encrypted with a specified encryption |
| | technique. |
| Device identity | Transfer files from CRM 40 if the CRM |
| | 40 device comprises and provides a |
| | device identifier (ID) that matches an ID |
| | on the server. |
| User identity | Transfer only those files from CRM 40 |
| | that were created by a particular user. |

In accordance with the “no repeat transmission” policy criterion, once a file has been transferred from the CRM 40 to the server 10, that same file will not again be transferred. Thus, when a user couples the CRM 40 to the user interface device 30, only those files that have not already been transferred will be transferred, thereby expediting the transfer process. In some embodiments, all files that have not previously been transferred are selected for transfer to the server 10. In other embodiments, files that have already been transferred are not selected and the remaining files may or may not be selected based on one or more of the other policy criteria. The processor 32 stores a tag associated with each file to indicate whether that file has been transferred to the server 10. Examination of the tags enables the processor 32 to determine which files have already been transferred to the server and which have not.

In accordance with the “file type” policy criterion, only those files of a specified file type will be transferred. For example, a user may specify a file type of Joint Photographic Experts Group (JPEG) as part of the policy 20. Then, when the user couples the CRM 40 to the user interface device 30, only JPEG files from among the files 42 will be transferred from the CRM 40 across the network 25 to the server 10. The user can specify one or more files types as part of the policy.

In accordance with the “file size” policy criterion, only those files whose size is equal to or less than a specified threshold will be transferred. For example, a user may specify a file size of 2 megabytes. Then, when the user couples the CRM 40 to the user interface device 30, only those files 42 having a size equal to or less than 2 megabytes will be transferred to the server. In some embodiments, only those files whose size is greater than the specified the file size are transferred. In yet embodiments, the user specifies a range of sizes and thus only files whose size falls within the specified range are transferred.

In accordance with the “file name” policy criterion, only those files whose name matches a specified name will be transferred. The user can specify a complete file name or a partial name with a “wild card.” For example, the user may specify a name of “picture*”. The asterisk (*) is a wild card and thus the specified name in this example includes all files whose name starts with “picture.”

In accordance with the MIME criterion, various standard file type identifiers are known to those skilled in the art, examples including HyperText Markup Language (HTML), Joint Photographic Experts Group (JPEG), Manolito Point-to-Point (MP2P), etc. These MIME types may be included in file selection policies when transferring files from the CRM 40. In some embodiments, file selection policies might be restricted to a list of known video MIME types.

In accordance with the metadata criterion, metadata refers to any data about a file, whether included as part of the file (examples include Exchangeable Image File (EXIF) and Tagged Image File Format (TIFF)), or whether located externally in a separate file or database. Examples of external metadata (i.e., metadata stored separate from the file to which the metadata pertains) comprise Resource Forks of the Apple Corp., Thumbs.db files, etc. Use of metadata for policy selection might be used to select only those files with EXIF data identifying a specified camera manufacturer (e.g., Sony Corp.). Another example is to use geographic metadata stored within or external to a video file describing the physical location of the camera at the time the video was created. A policy might select only video files that were created in Europe.

In accordance with the “file creation date” policy criterion, only those files created after (or before) a specified data are transferred from the CRM 40 to the server 10.

In an embodiment of the copyright policy criterion, only those files that are not tagged with a copyright notice or are not tagged with a copyright notice of a user-specified entity are transferred.

In accordance with the file descriptive information, authenticity, and ownership policy criteria, only files that can be authenticated as having been created by a specific user, or by a specific piece of equipment are selected to be transferred in some embodiments. These criteria are enforced by use of a message digest code (MAC) file that is used to verify that the file was created by someone or something in possession of a private key, or by other methods of verifying the authenticity of data.

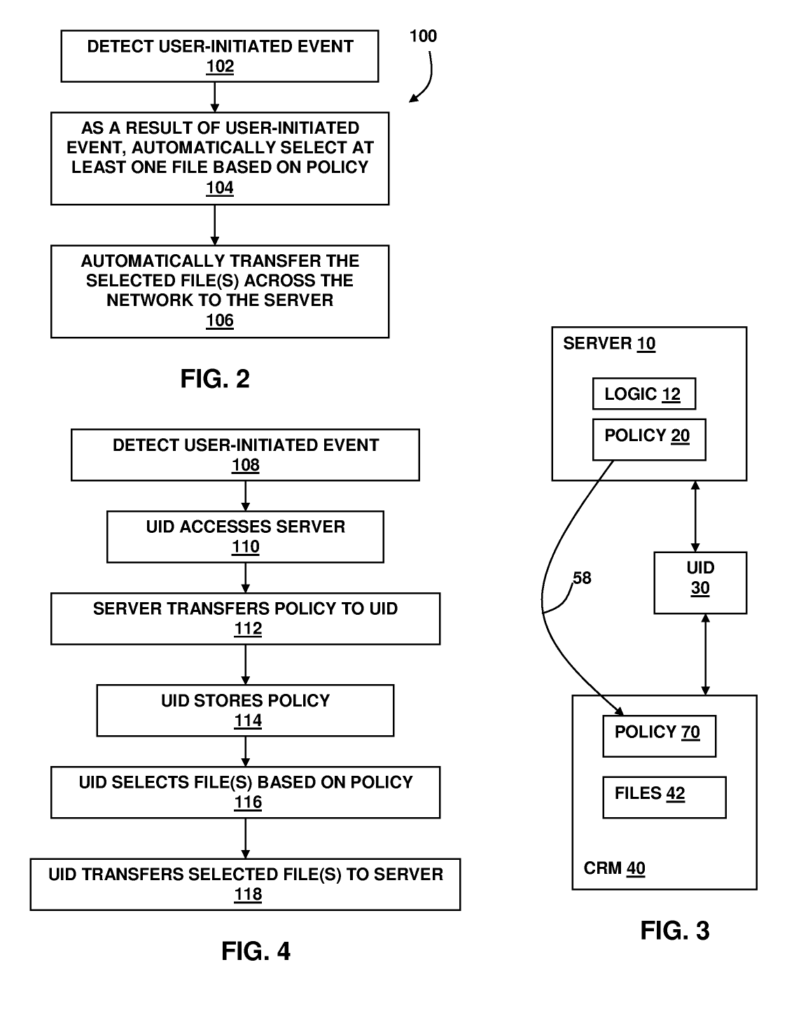

FIG. 2 illustrates a method 100 in accordance with various embodiments. At 102, a user-initiated event is detected. In various embodiments, the user-initiated event comprises the user coupling the CRM 40 to the user interface device 30. At 104, as a result of the user-initiated event, the method further comprises automatically selecting at least one file from files 42 from the CRM 40 based on the previously configured policy. For example, if the policy 20 is that only those files that have not previously been transferred are to be transferred, the user interface device 30 selects the files that have not already been transferred. At 106, the method further comprises automatically transferring the selected file(s) from the CRM 40 across the network 25 and to the network 10.

FIG. 3 illustrates an embodiment in which the policy 20 is provided from the server 10 to the CRM 40, and then used by the user interface device 30 to select the file(s) for transmission to the server 10. FIG. 4 illustrates this process. At 108, the user-initiated event is detected as described above. At 110, the user-interface device 30 accesses the server 10. At 112, the server 112 transfers a copy of the policy 20 to the user interface device 30, and the user interface device 30 stores the policy in the CRM 40. Arrow 58 in FIG. 3 illustrates the transference of the policy 20 from the server 10 to the CRM 40. A copy 70 of the policy is stored in the CRM 40 in FIG. 3. Referring again to FIG. 4, at 116 the user interface device 30 selects a file(s) based on policy 70 and, at 118, automatically transfers the selected file(s) across the network 25 to the server.

In some embodiments, the policy 70 remains on the CRM 40 for use the next time a user couples the CRM 40 to the user interface device 30. In other embodiments, the policy 20 is transferred from the server 10 to the CRM 40 each time the user couples the CRM 40 to the user interface device 30 regardless of whether the policy 70 is already present on the CRM 40. Thus, the automatic file transfer process uses the most current policy 20.

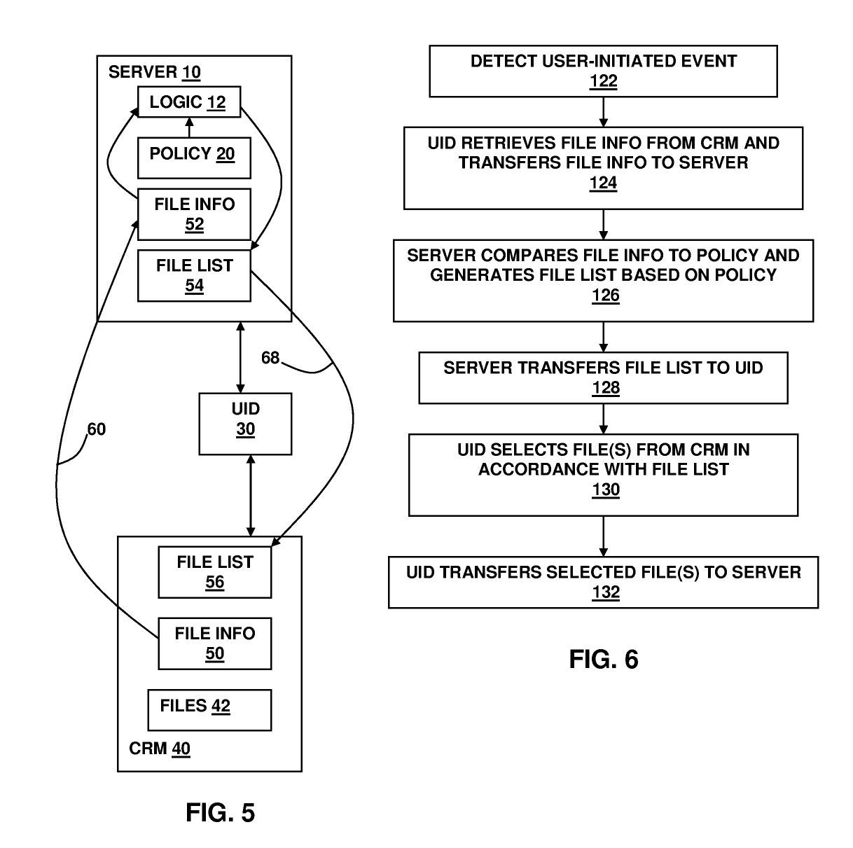

FIGS. 5 and 6 illustrate another embodiment in which a copy of the policy is not transferred from the server 10 to the user interface device 30 or CRM 40. Referring to FIGS. 5 and 6, at 122, the user-initiated event is detected as described above. At 124, the user interface device retrieves file information 50 from the CRM 40. The file information 50 comprises information about the files 42 stored on the CRM 40. In at least some embodiments, the file information 50 comprises information that is compared to the policy 20 to determine which files 42 are to be transferred from the CRM 40 to the server 10. As such, the file information 50 comprises any one or more of for each file: name, size, type, Mime type, creation and/or copyright date, metadata, the descriptive information, authenticity, NS ownership. In addition to such information about each file, the file information also comprises device identity and user identity. The device identity identifies the CRM 40 (e.g., model no. serial no., user-specified alphanumeric designation, etc.). The user identity is unique to a particular person or group of people (e.g., password, name, etc.). The user interface device 30 transfers the file information 50 across the network 25 to the server 10. The transfer of the file information 50 is depicted in FIG. 5 by arrow 60. As a result of the transfer, a copy 52 of the file information is present on the server 10.

At 126, the server 10 compares the file information 52 to policy 20 and generates a file list 54 accordingly. In some embodiments, the logic 12 of the server 10 receives the file information 52 and the policy 20 and generates the file list 54. The file list 54 comprises a list of the files 42 from the CRM 40 that are to be transferred from the CRM 40 to the server 10. The file list 52 is generated by the server 10 applying the policy 20 to the file information 52. At 128, the server 10 transfers the file list to the user interface device 30. This transfer is depicted by arrow 68 in FIG. 5. At this point, a copy 56 of the file list is present on the CRM 40.

At 128, the user interface device 30 selects a file(s) 42 in accordance with the file list 56, which itself was generated based on the policy 20. At 118, the user interface device 30 automatically transfers the selected file(s) across the network 25 to the server 10.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer-readable medium containing software that, when executed by a processor, causes the processor to:
as a result of a user-initiated event, automatically select at least one file from among a plurality of files based on a policy; and
automatically transfer the selected at least one file across a network.

2. The computer-readable medium of claim 1 wherein the software causes the processor to automatically select the at least one file based on a policy that comprises selection of only those file that have not previously been transferred across the network.

3. The computer-readable medium of claim 1 wherein the software causes the processor to automatically select the at least one file based on a policy that comprises selection of files based on one or more of file type, file size, file date, file copyright, and file encryption.

4. The computer-readable medium of claim 1 wherein the software further causes the processor to retrieve the policy across said network.

5. The computer-readable medium of claim 1 wherein the software causes the processor to compare the plurality of files to the policy.

6. The computer-readable medium of claim 1 wherein the plurality of files are stored on the computer-readable storage medium.

7. The computer-readable medium of claim 1 wherein the plurality of files comprise content selected from a group consisting of images, video, text, authentication digests, metadata, and audio and combinations thereof.

8. The computer-readable medium of claim 1 wherein the software causes the processor automatically select at least two files from among the plurality of files.

9. A system, comprising:
a user input device;
logic that accepts input from said user input device to configure a policy, said policy usable by a remote device to select a file from among a plurality of files based on the policy for transmission to the system.

10. The system of claim 9 wherein the policy comprises file type.

11. The system of claim 9 wherein the policy comprises file size.

12. The system of claim 9 wherein the policy specifies whether a file that has already been transmitted to the system should be re-transmitted.

13. The system of claim 9 wherein the policy comprises a device identity or a user identity.

14. The system of claim 9 wherein the policy comprises metadata.

15. The system of claim 9 wherein said logic receives file information from a network and generates a file list based on said file information and based on said policy, said file list identifying one or more files to be transferred to the system.

16. A method, comprising:
detecting a user-initiated event;
as a result of said user-initiated event, automatically selecting at least one file from among a plurality of files based on a policy; and
automatically transferring the selected at least one file across a network.

17. The method of claim 16 wherein detecting the user-initiated event comprises determining that a peripheral device containing said plurality of files has been coupled to a computer.

18. The method of claim 16 wherein automatically selecting at least one file from among a plurality of files based on a policy comprises automatically selecting at least one file from among a plurality of files based on a policy that comprises a feature selected from a group consisting of not selecting a file that has already been transferred across the network and file type.

19. The method of claim 16 further comprising accessing the policy across a network.

20. The method of claim 16 further comprising configuring the policy.
